(19) United States
(12) Patent Application Publication
(10) Pub. No.: US 2014/0277621 A1
(43) Pub. Date: Sep. 18, 2014

(54) MONITORING HEALTH AND EXERCISE WITH A PREMISE SECURITY OR AUTOMATION SYSTEM

(71) Applicant: Vivint, Inc., Provo, UT (US)

(72) Inventors: Alex J. Dunn, Orem, UT (US); James Ellis Nye, Alpine, UT (US); Jeremy Bruce Warren, Draper, UT (US)

(73) Assignee: Vivint, Inc., Provo, UT (US)

(21) Appl. No.: 14/207,195

(22) Filed: Mar. 12, 2014

Related U.S. Application Data
(60) Provisional application No. 61/786,227, filed on Mar. 14, 2013.

(51) Int. Cl. G05B 15/02

(52) U.S. Cl. CPC G05B 15/02
USPC 700/83

(57) ABSTRACT

The present systems and methods are directed to a security or automation system that is configured for monitoring health and exercise conditions of an individual. A security or automation system may include at least one sensor for sensing a medical condition and at least one module for receiving sensed data from the at least one sensor. The security or automation system may further include a communication device for conveying information based on the sensed data to a remote site.

### CROSS REFERENCES

This application claims priority from co-pending U.S. Provisional Patent Application No. 61/786,227 entitled “MONITORING HEALTH AND EXERCISE WITH A SECURITY OR AUTOMATION SYSTEM,” which was filed Mar. 14, 2013.

### TECHNICAL FIELD

This disclosure relates generally to security systems and/or automation systems and, more specifically, to monitoring health and exercise with a security and/or automation

### BACKGROUND

Security systems are widely used to protect property and for personal safety. Security systems generally include a control panel, which controls the overall operation of the system, one or more keypads for user access to the system, and various detectors and sensors.

Security systems may generate an alarm in response to any number of events, such as unauthorized entry, fire, a medical emergency or manual alarm activation. Further, a security system may be associated with a service that remotely monitors the status of the security system. Thus, if the security system generates an alarm, a notification signal may be transmitted via a wired and/or wireless communications link to a central station. Upon receiving the notification signal, security service personnel at the central station may attempt to contact the property owner (i.e., the party at the secured location) to verify the alarm. If it is appropriate to do so, the security service personnel may, upon confirmation of the alarm, contact an emergency response agency (e.g., the police department, the fire department or an emergency medical team, etc.).

Security systems have therefore enhanced the ability of homeowners and businesses to monitor their premises and to protect against break-ins and the crimes that can accompany them (e.g., theft, damage to property, assault and battery, stalking, intrusion into privacy, etc.).

Automation systems for buildings (e.g., homes, etc.) and space in buildings (e.g., apartments, condominiums, retail space, office space, etc.) are installed for convenience, efficiency and to enable the occupants of a building or space within a building to remotely control devices within that space.

### SUMMARY

In a specific embodiment, a security or automation system may include a control unit including a user interface. The control unit may be configured to receive heath related data from at least one device and transmit information related to the health related data to a remote site.

In another specific embodiment, a system includes a security or automation system control unit, or panel. The control unit may be configured to receive heath related data from at least one device and issue an alarm event in response to received health data.

In yet another specific embodiment, a security or automation system may comprise at least one sensor for sensing a health related condition and at least one module for receiving sensed data from the at least one sensor. The security or automation system may further include a communication device for conveying information based on the sensed data to a remote site.

Of course, methods of operating a system are also within the scope of the present invention. Such a method may include receiving health related data at a security or automation system control unit. The method may further include processing the data at the security or automation system control unit.

In another specific embodiment, a method may include processing sensed health related data at the security or automation security or automation or automation system control unit and tracking health conditions of a user based on the processed health related data. Further, the method may include conveying health related status information based on tracked health conditions of a user via a user interface of the security or automation security or automation or automation system.

Yet other embodiments of the present invention comprise computer-readable media storage storing instructions that when executed by a processor cause the processor to perform instructions in accordance with one or more embodiments described herein.

Other aspects, as well as features and advantages of various aspects, of the present invention will become apparent to those of skill in the art though consideration of the ensuing description, the accompanying drawings and the appended claims.

### BRIEF DESCRIPTION OF THE DRAWINGS

FIG. 1 illustrates an embodiment of a security or automation system;

FIG. 2 is a block diagram of a control unit of a security or automation system, according to an embodiment of the present disclosure;

FIG. 3 illustrates a system including a control unit of a security or automation system coupled to a remote site via a network, according to an embodiment of the present invention;

FIG. 4 depicts a health and exercise module, according to an embodiment of the present invention;

FIG. 5 depicts a system including a health and exercise module coupled to a plurality of devices, in accordance with an embodiment of the present invention;

FIG. 6 is a flowchart of a method, according to an embodiment of the present invention; and

FIG. 7 is a flowchart of another method, according to an embodiment of the present invention.

### DETAILED DESCRIPTION

Referring in general to the accompanying drawings, various embodiments of the present invention are illustrated to show the structure and methods for monitoring or controlling local power generation or monitoring or controlling interaction of a local power system with a public utility grid. Common elements of the illustrated embodiments are designated with like numerals. It should be understood that the figures presented are not meant to be illustrative of actual views of any particular portion of the actual device structure, but are merely schematic representations which are employed to more clearly and fully depict embodiments of the invention.

The following provides a more detailed description of the present invention and various representative embodiments thereof. In this description, functions may be shown in block diagram form in order not to obscure the present invention in unnecessary detail. Additionally, block definitions and partitioning of logic between various blocks is exemplary of a specific implementation. It will be readily apparent to one of ordinary skill in the art that the present invention may be practiced by numerous other partitioning solutions. For the most part, details concerning timing considerations and the like have been omitted where such details are not necessary to obtain a complete understanding of the present invention and are within the abilities of persons of ordinary skill in the relevant art.

In this description, some drawings may illustrate signals as a single signal for clarity of presentation and description. It will be understood by a person of ordinary skill in the art that the signal may represent a bus of signals, wherein the bus may have a variety of bit widths and the present invention may be implemented on any number of data signals including a single data signal.

As noted above, a security or automation system may include one or more sensors linked to a control panel, which may include an interface that can be used by a user. It is noted that a “control panel” may also be referred to herein as a “control unit” or a “system controller,”

Via a control panel, a user may arm (e.g., when leaving their residence) and disarm (e.g., when entering their residence) the security system. The control panel may provide other functionality, such as a physical duress alarm, two-way voice communication, a siren, etc. Security sensors may be configured to monitor for various events. For example, a door/window sensor may be configured to detect when a door/window has been opened, a motion detector may be configured to detect motion. Other sensors may be configured to detect breaking of glass.

In addition to a local control panel, which monitors sensor activity on premises, a security system may include a central monitoring system. For residential security systems, a remote central monitoring system can be a third party vendor's in some cases, the same company that installed the alarm system. For commercial and industrial security systems, security or other personnel may monitor the premises. In commercial and industrial settings, the control panel can be integrated into a larger security system. In any event, when sensor monitoring is activated and a sensor indicates a physical disturbance, the control panel can activate an alarm. In response to an alarm, the control panel can activate an audible siren and/or send an indication of the alarm to a central monitoring entity via a security event signal. The central monitoring entity can then initiate a response, such as contacting the owner of the premises, sending security personnel, contact authorities, or a combination thereof.

FIG. 1 illustrates an embodiment of a security system 100, which may also be referred to as an “alarm system.” Security system 100 includes sensors 101, a control unit 102, monitoring system 103, and remote activation system 131. Communication links 104 (e.g., a combination of wired and wireless communication links) couple sensors 101 to control unit 102. Wired communication links can include circuit loops that are either detected as closed or open. In some embodiments, sensors 101 and control unit 102 are located on the same premises, such as in the same residence or in the same building. Communication link 106 (e.g., a wired telephone connection, wired or wireless network connection, cellular connection, etc., or combination thereof) couples control unit 102 to monitoring system 103.

Generally, sensors 101 include any of a variety of different types of sensors, such as door and window sensors, motion sensors, glass break sensors (e.g., detecting a physical break or detecting the sound of a glass break), etc. Generally, control unit 102 is configured to monitor sensors 101 for alarm conditions via communication links 104 and relay alarms to monitoring system 103 via communication link 106.

Control unit 102 includes sensor monitoring module 111, user interface 112, and alarm module 113. Sensor monitoring module 111 is configured to monitor sensors 101. Sensors 101 can sense and/or indicate a change in their physical surroundings (e.g., a normally closed connection becomes open, a signal indicating that the sound of breaking glass was detected, etc.), which may be indicative of an unauthorized access, on communication links 104. For example, a circuit connected to a door sensor can transition from closed to open (or at least to a resistance exceeding a pre-determined resistance threshold) indicating that a door has been opened. A motion sensor can send an electrical signal indicative of detected motion. Sensor monitoring module 111 may monitor communication links 104 for indications and signals sent from sensors 101. Upon sensor monitoring module 111 receiving an indication or signal of a change in physical surroundings, sensor monitoring module 111 may send the indication or signal to alarm module 113. When appropriate, alarm module 113 can treat a monitored indication or signal from a sensor as an alarm condition.

User interface 112 can include an input interface and an output interface. The input interface can comprise a physical input interface or virtual input interface that includes one or more a numeric key pad (e.g., for entering a disarm code, etc.), sensor activation buttons, physical duress buttons, etc. The input interface can also include a condenser for receiving audio input and/or communicating with monitoring system 103. The output interface includes an output display device that display system status, such as armed, disarmed, sensors/zones that have detected change in physical surroundings, etc. The output interface can also include a speaker that audibly outputs information similar to that displayed on the output display device. The speaker can also be used by monitoring system 103 to communicate with a user of control unit 102.

FIG. 2 is a block diagram of control unit 102, according to an embodiment of the present invention. Control unit 102 includes a processor 122, memory 140, and user interface 112. User interface 112 includes various input/output (I/O) devices, such as a display 134, which may comprise a touch screen, a transducer 136, a camera 138, a keypad 142, and a speaker 144. Control unit 102 may further include a transceiver 146 for receiving and transmitting data (e.g., video, audio, images) over a network. It is noted that a “communication interface” as referred to herein may comprise transceiver 146 and user interface 112.

Generally, control unit 102 may operate under control of an operating system stored in memory 140, and interface with a user to accept inputs and commands and to present outputs through user interface 112. Control unit 102 may also implement a compiler (not shown) which allows one or more application programs (not shown) written in a programming language to be translated into processor 122 readable code. In one embodiment, instructions implementing an application program may be tangibly embodied in a computer-readable medium. Further, an application program may include instructions which, when read and executed by processor 122, may cause processor 122 to perform the tasks to implement and/or use embodiments of the present disclosure. It is noted that an application program and/or operating instructions may also be tangibly embodied in memory 140 and/or data communications devices, thereby making a computer program product or article of manufacture according to an embodiment the present disclosure. As such, the term “application program” as used herein is intended to encompass a computer program accessible from any computer readable device or media. Furthermore, portions of the application program may be distributed such that some of the application program may be included on a computer readable media within control unit 102, and some of the application program may be included in a remote device, such as a remote computer.

Memory 140 may include a video conference module 145 and a health and exercise module 150, which may include various modules for monitoring and tracking health and exercise related conditions of an individual. Video conference module 145 and health and exercise module 150 may each comprise hardware, software, firmware, or a combination thereof. Memory 140 may also include one or more databases 148 for storing data. In FIG. 2, video conference module 145 and health and exercise module 150 are illustrated as being stored in memory 140 so as to be accessible and/or executable by processor 122. However, it should be understood that video conference module 145 and health and exercise module 150 may be otherwise stored, even remotely.

According to various embodiments of the present invention, video conference module 145 may be configured for establishing a video and audio communication session with at least one other electronic device. More specifically, video conference module 145 may identify a network address of a device and, thereafter, establish a communication session with the device using the identified network address. Further, a communication interface, which may comprise user interface 112 and transceiver 146, may be configured for receiving and transmitting audio and video data over a network via an established communication session.

A system 200, in accordance with an embodiment of the present invention, is illustrated in FIG. 3. System 200 comprises control unit 102 communicatively coupled to a remote site 206 via a communication network 204. Accordingly, as will be understood by a person having ordinary skill in the art, control unit 102 may be configured to transmit and receive video and audio content (e.g., a live video feed and/or a video message) to and from remote site 206 via communication network 204 to enable a user of control unit 102 to communicate with an individual at remote site 206. Communication network 204 may comprise any suitable network that enables video conferencing between two or more electronic devices. For example, network 204 may comprise a local area network or a wide area network. Furthermore, it is noted that network 204 may comprise a wireless network, a wired network, or a combination thereof. Although system 200 is illustrated as having only two communicatively coupled devices, the present invention is not so limited. Rather, control unit 102 may be communicatively coupled to any number of remote sites via communication network 204. By way of example only, remote site 206 may comprise a medical facility (e.g., a doctor's office). In this example, medical personnel at the medical facility may communicate with a user of control unit 102 via a video conference.

As illustrated in FIG. 4, health and exercise module 150 may include various modules for monitoring and tracking health related conditions of an individual. More specifically, health and exercise module 150 includes a health module 151, which may include various health related modules. As non-limiting examples, health module 151 may include a body composition module 154, a blood pressure module 156, and a body weight module 158. Although health module 151 is depicted as including only body composition module 154, blood pressure module 156, and body weight module 158, the invention is not so limited. Rather, health module 151 may include modules for other heath related conditions, such as a cholesterol, heart rate, and temperature.

Health and exercise module 150 further includes an exercise module 160, which may include various exercise related modules. By way of example only, exercise module 160 may include a treadmill module 162, a pedometer module 164, and a stationary bicycle module 166. Although exercise module 160 is depicted as including only treadmill module 162, pedometer module 164, and stationary bicycle module 166, the invention is not so limited. Rather, exercise module 160 may include other exercise related modules, such as an elliptical module, a rowing machine module, and a stair stepper module. Health and exercise module 150 may further include other modules, such as a dietary module 168 and a medication module 170.

It is noted that although control unit 102 is illustrated as having multiple modules, wherein each module is configured to perform specific functionality, the functionality of control unit 102 may exist within one or more modules. It is further noted, in addition to including data associated with vital signs of an individual, the term “health related data” as used herein may include any data related to the health of an individual, including exercise related data, dietary data, and medication data.

FIG. 5 illustrates health and exercise module 150 coupled to a plurality of devices (e.g., sensors, exercise equipment, and a medication dispenser). It is noted that health and exercise module 150 may communication with each device via a wired connection, a wireless connection, or a combination thereof. With reference to FIGS. 2-5, body composition module 154 may be configured to receive health related data from a sensor, such as a body composition measurement device 180. More specifically, as an example, body composition module 154 may be configured to receive a body composition measurement of an individual, who has used or is using body composition measurement device 180. Upon receipt of heath related data, body composition module 154 may process the received data and may generate data, such as one or more reports (e.g., including body composition history of an individual), instructional data, health warnings, status of one or more individual goals, etc. Generated data may be displayed via user interface 112.

Further, body composition module 154 may be configure to store data (i.e., data received from body composition measurement device 180 and/or generated data) in database 148. In addition, body composition module 154 may be configured to convey health related data concerning an individual's body composition information to a remote site, such as remote site 206. More specifically, as one example, body composition module 154 may be configured to transmit health related data to a medical facility for viewing by medical personnel (e.g., the individual's doctor or nurse). As another example, body composition module 154 may be configured to transmit health related data concerning the individual to a remote site (e.g., a desktop or a mobile device) for viewing by a relative or a friend of the individual. Furthermore, control unit 102 may be configured to receive data from a remote site. As an example, control unit 102 may be able to receive and display (via display 134) instructional data sent from a medical facility.

Similarly, blood pressure module 156 may be configured to receive health related data from a sensor, such as a blood pressure monitor 182. More specifically, as an example, blood pressure module 156 may be configured to receive a blood pressure reading of an individual, who has used or is using blood pressure monitor 182. Upon receipt of heath related data, blood pressure module 156 may process the received data and may generate data such as one or more reports (e.g., including blood pressure history of an individual), instructional data, health warnings, status of one or more individual goals, etc. Generated data may be displayed via user interface 112.

Further, blood pressure module 156 may be configured to store data (i.e., data received from blood pressure monitor 182 and/or generated data) in database 148. In addition, blood pressure module 156 may be configured to convey health related data concerning blood pressure information to a remote site, such as remote site 206. More specifically, as one example, blood pressure module 156 may be configured to cause health related data to be transmitted to a medical facility for viewing by medical personnel (e.g., the individual's doctor or nurse). As another example, blood pressure module 156 may be configured to cause health related data to be transmitted to a relative or friend of the individual (e.g., via a computing device). Furthermore, control unit 102 may be configured to receive data from the remote destination. As an example, control unit 102 may be able to receive and display (e.g., via display 134) instructional data sent from a medical facility.

Body weight module 158 may be configured to receive data from a sensor, such as a weight scale 184. More specifically, as an example, body weight module 158 may be configured to receive of weight measurement of an individual, who is or was positioned on weight scale 184. Upon receipt of heath related data, body weight module 158 may process the received data and generate data such as one or more reports (e.g., including body weight history of an individual), instructional data, health warnings, status of one or more individual goals, etc. Generated data may be displayed via user interface 112.

Further, body weight module 158 may be configured to store data (i.e., data received from weight scale 184 and/or generated data) in database 148. In addition, body weight module 158 may be configured to convey health related data concerning body weight information to a remote site, such as remote site 206. More specifically, body weight module 158 may be configured to cause health related data to be transmitted to a medical facility for viewing by medical personnel (e.g., the individual's doctor or nurse). As another example, body weight module 158 may be configured to cause health related data to be transmitted to a relative or friend of the individual (e.g., via a computing device). Furthermore, control unit 102 may be configured to receive data from a remote site. As an example, control unit 102 may be able to receive and display (e.g., via display 134) instructional data sent from a medical facility.

Treadmill module 162 may be configured to receive a signal from a treadmill 186. For example, upon completion a workout, treadmill module 162 may receive a data signal from treadmill 186 including a status of the completed workout (e.g., duration, distance completed, calories burned, etc.). Upon receipt of a data signal from treadmill 186, treadmill module 162 may further be configured to process the data and may generate one or more reports (e.g., including an exercise history of an individual), compliance data, instructional data, status of one or more individual goals, etc. Generated data may be displayed via user interface 112.

Further, treadmill module 162 may be configure to store data (i.e., data received from treadmill 186 and/or generated data) in database 148. In addition, treadmill module 162 may be configured to convey health related data concerning exercise information to a remote site, such as remote site 206. More specifically, treadmill module 162 may be configured to cause exercise related data to be transmitted to a medical facility for viewing by medical personnel (e.g., the individual's doctor or nurse). As another example, treadmill module 162 may be configured to cause health related data to be transmitted to a relative or friend of the individual (e.g., via a computing device). Furthermore, control unit 102 may be configured to receive data from a remote site. As an example, control unit 102 may be able to receive and display (e.g., via display 134) instructional data sent from a medical facility.

Pedometer module 164 may be configured to receive a signal from a pedometer 188. For example, upon completion of a walk or a run, or at a specified time (e.g., at 10:00 PM each day), pedometer module 164 may be configured to receive a data signal from pedometer 188 including a distance traveled. Upon receipt of a data signal from pedometer 188, pedometer module 164 may further be configured to process the data and may generate one or more reports (e.g., including an exercise history of an individual), compliance data, instructional data, status of one or more individual goals, etc. Generated data may be displayed via user interface 112.

Further, pedometer module 164 may be configure to store data (i.e., data received from pedometer 188 and/or generated data) in database 148. In addition, pedometer module 164 may be configured to convey health related data concerning exercise information to a remote site, such as remote site 206. More specifically, pedometer module 164 may be configured to cause exercise related data to be transmitted to a medical facility for viewing by medical personnel (e.g., the individual's doctor or nurse). As another example, pedometer module 164 may be configured to cause health related data to be transmitted to a relative or friend of the individual (e.g., via a computing device). Furthermore, control unit 102 may be configured to receive data from a remote site. As an example, control unit 102 may be able to receive and display (e.g., via display 134) instructional data sent from a medical facility.

Stationary bicycle module 166 may be configured to receive a signal from a stationary bicycle 190. For example, upon completion a workout, stationary bicycle module 166 may receive a data signal from stationary bicycle 190 including a status of the completed workout (e.g., duration, distance completed, calories burned, etc.). Upon receipt of a data signal from stationary bicycle 190, stationary bicycle module 166 may further be configured to process the data and may generate one or more reports (e.g., including an exercise history of an individual), compliance data, instructional data, status of one or more individual goals, etc. Generated data may be displayed via user interface 112.

Further, stationary bicycle module 166 may be configured to store data (i.e., data received from stationary bicycle 190 and/or generated data) in database 148. In addition, stationary bicycle module 166 may be configured to convey health related data concerning exercise information to a remote site, such as remote site 206. More specifically, stationary bicycle module 166 may be configured to cause exercise related data to be transmitted to a medical facility for viewing by medical personnel (e.g., the individual's doctor or nurse). As another example, stationary bicycle module 166 may be configured to cause health related data to be transmitted to a relative or friend of the individual (e.g., via a computing device). Furthermore, control unit 102 may be configured to receive data from a remote site. As an example, control unit 102 may be able to receive and display (e.g., via display 134) instructional data sent from a medical facility.

Dietary module 168 may be configured to receive data via user interface 112. As an example, a user may enter, via user interface 112, food and drink intake on a periodic basis (e.g., once a day). Upon receipt of user input, dietary module 168 may be configured to process the data and may generate one or more reports (e.g., including dietary history of an individual), compliance data, instructional data, status of one or more individual goals, warnings, etc. Generated data may be displayed via user interface 112.

Further, dietary module 168 may be configured to store data (i.e., data received from user interface 112 and/or generated data) in database 148. In addition, dietary module 168 may be configured to convey health related data concerning dietary information to a remote site, such as remote site 206. More specifically, dietary module 168 may be configured to cause health related data to be transmitted to a medical facility for viewing by medical personnel (e.g., the individual's doctor or nurse). As another example, dietary module 168 may be configured to cause health related data to be transmitted to a relative or friend of the individual (e.g., via a computing device). Furthermore, control unit 102 may be configured to receive data from a remote site. As an example, control unit 102 may be able to receive and display (via display 134) instructional data sent from a medical facility.

Medication module 170 may also be configured to receive data via user interface 112. For example only, a user may enter medication intake on a periodic basis (e.g., once a day). Upon receipt of user input, medication module 170 may be configured to process the data and may generate one or more reports (e.g., including a medication history of an individual), compliance data, instructional data, warnings, etc. Generated data may be displayed via user interface 112.

Further, medication module 170 may be configured to store data (i.e., data received from user interface 112 and/or generated data) in database 148. In addition, medication module 170 may be configured to convey health related data concerning medication information to a remote destination. More specifically, medication module 170 may be configured to cause health related data concerning medication information to be transmitted a medical facility for viewing by medical personnel (e.g., the individual's doctor or nurse). As another example, dietary module 168 may be configured to cause health related data concerning medication information to be transmitted to a relative or friend of the individual (e.g., via a computing device). Furthermore, control unit 102 may be configured to receive data from a remote site. As an example, control unit 102 may be configured to receive and display (via display 134) instructional data sent from a medical facility.

With continued reference to FIG. 5, a security or automation system, such as system 100 (see FIG. 1) may include a medication dispenser 192 configured to dispense a desired amount of medication at a desired time. Further, dispenser 192 may include a sensor (not shown) positioned proximate at a dispenser region. Further, dispenser 192 may be communicatively coupled to medication module 170 and, therefore, may transmit a control signal, a data signal, or both to medication module 170. In the event medication is dispensed and not removed within a specified time duration (e.g., an hour), dispenser 192 may issue an alarm event. In one example, dispenser 192 may convey an audible and/or a visual alarm at dispenser 192. In another example, dispenser 192 may convey a signal to medication module 170, which may cause an alarm event (e.g., an audible and/or a visual alarm) to be issued via alarm module 113 (see FIG. 1). Further, medication module 170 may be configured to issue an alarm event, which may indicate that medication has not be taken as required, to remote site 206, which may be a medical facility or a location of a relative or friend of the individual.

It is noted that health and exercise module 150 may be configured to compile data from one or more modules. For example, health and exercise module 150 may compile data from body composition module 154 and treadmill module 162, process the compiled data, generate one or more reports, compliance data, instructional data, status of one or more goals, warnings, etc. Generated data may be displayed via user interface 112, stored in database 148 and/or conveyed to a remote site.

As will be appreciated by a person having ordinary skill in the art, embodiments of the present invention may enable medical personnel to view a patient's health related data and provide the patient with medical advice without making a home visit. Thus, medical costs may be reduced.

FIG. 6 is a flowchart of a method 600, according to an embodiment of the present invention. Method 600 includes receiving 602 health related data at a security or automation system control unit. Method 600 further includes receiving 604 a signal comprising health related data at a security or automation system control unit.

FIG. 7 is a flowchart of another method 650, in accordance with an embodiment of the present invention. Method 650 includes processing 652 sensed health related data at the security or automation system control unit. Additionally, method 650 includes tracking 654 health conditions of a user based on the processed health related data. Further, method 650 includes conveying 656 health related status information based on tracked health conditions of a user via a user interface of the control unit.

Although the foregoing description contains many specifics, these should not be construed as limiting the scope of the invention or of any of the appended claims, but merely as providing information pertinent to some specific embodiments that may fall within the scopes of the invention and the appended claims. Features from different embodiments may be employed in combination. In addition, other embodiments of the invention may also be devised which lie within the scopes of the invention and the appended claims. The scope of the invention is, therefore, indicated and limited only by the appended claims and their legal equivalents. All additions, deletions and modifications to the invention, as disclosed herein, that fall within the meaning and scopes of the claims are to be embraced by the claims.

What is claimed is:

1. A premise security or premise automation system, comprising:
a control unit located within a premise monitored by the system and including a user interface and configured to:
receive health related data from at least one device remote from a panel; and
transmit information related to the health related data to a remote site.

2. The premise security or premise automation system of claim 1, further comprising the remote site.

3. The premise security or premise automation system of claim 1, wherein the at least one device comprising one of a body composition measurement device, a blood pressure monitor, a weight scale, a treadmill, a pedometer, a stationary bicycle, and a medication dispenser.

4. The premise security or premise automation system of claim 1, further configured to generate a report based on data received from the at least one device.

5. The premise security or premise automation system of claim 1, further configured to issue an alarm event upon receipt of heath related data.

6. The premise security or premise automation system of claim 1, wherein the remote site includes a medical facility.

7. The premise security or premise automation system of claim 1, wherein the control unit is further configured to receive the health related data via the user interface.

8. The premise security or premise automation system of claim 1, wherein the health related data comprises at least one of from a group consisting of a body composition measurement, a blood pressure measurement, a weight measurement, and an exercise summary.

9. The premise security or premise automation system of claim 1, wherein the control unit is configured to wirelessly receive the health related data from the at least one device.

10. A premise security system incorporated into a building, comprising:
a control unit configured to:
receive health related data from at least one device remote from a security control unit; and
issue an alarm event in response to receiving the health related data.

11. The premise security system of claim 10, wherein the health related data comprises a notification of a failure to remove medication from a medication dispenser.

12. The premise security system of claim 10, wherein the alarm event comprises a notification conveyed via an alarm module.

13. The premise security system of claim 10, wherein the alarm event is conveyed to a remote site.

14. The premise security system of claim 13, wherein the remote site comprises a medical facility.

15. The premise security system of claim 10, wherein the at least one device comprises a weight scale.

16. A method, comprising:
receiving health related data at a premise security system control unit incorporated into a building; and
processing the health related data at the premise security system control unit or at a remote site.

17. The method of claim 16, further comprising generating the health related data via at least one device.

18. The method of claim 16, wherein receiving health related data includes receiving the health related data from at least one of a body composition measurement device, a blood pressure monitor, a weight scale, a treadmill, a pedometer, a stationary bicycle, and a medication dispenser.

19. The method of claim 16, further comprising transmitting information based on the health related data to the remote site.

20. The method of claim 16, further comprising receiving health related instructional information at the premise security system control unit.
